(19) United States
(12) Patent Application Publication
(10) Pub. No.: US 2006/0220516 A1
(43) Pub. Date: Oct. 5, 2006

(54) Color picture tube

(75) Inventor: Shuji Makimoto, Osaka (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ld., Takatsuki-shi (JP)

(21) Appl. No.: 11/392,336

(22) Filed: Mar. 29, 2006

Related U.S. Application Data
(63) Continuation-in-part of application No. 11/371,588, filed on Mar. 9, 2006, now abandoned.

(30) Foreign Application Priority Data
Mar. 31, 2005 (JP) 2005-102935

(51) Int. Cl. H01J 29/80

(52) U.S. Cl. 313/402

(57) ABSTRACT

A perforated curved-surface portion of a shadow mask in a color picture tube satisfies the following conditions. At an arbitrary point on an X-axis and a Y-axis, Rᵣ is one radius of curvature of a main radius of curvature group, and R₁ is the other radius of curvature of the main radius of curvature group. On the Y-axis, |Rᵣ|<|R₁| is satisfied at an arbitrary point in a range where the distance from a center is L_{Y} or less. On the X-axis, |Rᵣ|>|R₁| is satisfied at an arbitrary point in a range where the distance from the center is Lₓ/3 or less, and |Rᵣ|<|R₁| is satisfied at an arbitrary point in a range where the distance from the center is 3 Lₓ/4 to L_{X}. This can enhance mask curved-surface strength without degrading resolution and color purity.

### CROSS REFERENCE TO RELATED APPLICATIONS

This application is a Continuation-in-Part of application Ser. No. 11/371,588, filed Mar. 9, 2006, which application is incorporated herein by reference.

### BACKGROUND OF THE INVENTION

1. Field of the Invention

The present invention relates to a color picture tube having a shadow mask, and in particular, to the shape of a shadow mask.

2. Description of Related Art

A color picture tube of a shadow mask type can be produced at lower cost, compared with picture devices of the other systems. Recently, a color picture tube has been introduced, in which the transmittance of a panel glass of the color picture tube is decreased while surface treatment and the like are omitted in order to satisfy the demand for further reduction in cost, while the contrast and the like comparable to those of a conventional color picture tube are maintained. However, in such a low-cost color picture tube, due to the low transmittance of a panel glass, when a panel inner surface and a panel outer surface have the same radii of curvature as those of the conventional color picture tube, the darkness in a peripheral portion of a screen becomes larger than that in a center portion thereof in accordance with the thickness of the panel glass, compared with the conventional color picture tube, with the result that the uniformity of darkness (black uniformity) with respect to the entire screen is impaired.

For example, in the case of using a low-transmittance panel in a color picture tube with an aspect ratio of 16:9, a horizontal end portion (major axis end portion: X-axis end portion) becomes darker than a vertical end portion (short axis end portion: Y-axis end portion), and a diagonal end portion (D-axis end portion) becomes the darkest in the entire screen. Although the X-axis end portion and the D-axis end portion are darker than the Y-axis end portion, the length from the screen center to the Y-axis end portion is smallest, so that the difference between the darkness in the screen center and the darkness at the Y-axis end portion is most conspicuous. In the X-axis (horizontal axis) direction and the D-axis (diagonal axis) direction, the darkness increases gradually over the longer distances, compared with that in the Y-axis (vertical axis) direction, so that the difference in darkness in these directions is not so conspicuous.

In order to keep black uniformity of the screen, a method is considered for increasing the radius of curvature in the Y-axis direction of a panel inner surface compared with that of the conventional example, thereby reducing panel thickness. However, if the radius of curvature in the Y-axis direction of a shadow mask merely is increased in accordance with the radius of curvature in the Y-axis direction of the panel inner surface, the resistance (hereinafter, referred to as “shock resistance”) of a shadow mask with respect to the shock during production, the shock experienced during transportation after a product is shipped, and the like is decreased. Thus, in order to use a low-transmittance panel that can be reduced in cost, it is necessary to keep a mask curved-surface strength (i.e., mask shock resistance) equal to that of the conventional example, while increasing the radius of curvature in the Y-axis direction of the shadow mask.

On the other hand, in a flat screen color picture tube of a shadow mask type, although a panel outer surface is flat, a panel inner surface has a curved surface shape having a predetermined radius of curvature, considering the visibility and the arrangement pitch of phosphors. Furthermore, a shadow mask having a color selection function, placed at a predetermined interval from a phosphor layer provided on the panel inner surface is formed by pressing, and the curved surface thereof is determined considering the radius of curvature of the panel inner surface and the arrangement pitch of phosphors. The shadow mask needs to have a curved surface shape with a predetermined radius of curvature or less so as to keep its own curved surface shape.

The mask curved-surface strength of such a shadow mask is enhanced by enlarging the sagging amount, which is a displacement amount of a mask surface with respect to the center, in a peripheral portion, i.e., by decreasing the radius of curvature in the peripheral portion. However, even if the mask curved-surface strength can be enhanced, the resolution in the peripheral portion decreases. Furthermore, as a method for enhancing the mask curved-surface strength, there is a method for increasing the thickness of a shadow mask, which is disadvantageous in terms of cost and a screen grade. Thus, in order to enhance the mask curved-surface strength while keeping the resolution and screen grade equal to those of the conventional example, it is necessary to devise the curved surface shape of the shadow mask. Simply, a method can be considered for increasing the radius of curvature in a region from the center portion of the shadow mask to the vicinity of an intermediate portion (substantially middle portion between the center portion and the peripheral portion), and decreasing the radius of curvature in the peripheral portion, thereby enhancing the mask curved-surface strength while keeping the same average radius of curvature and sagging amount. However, according to such a method, the radius of curvature of the shadow mask from the center portion to the intermediate portion of the shadow mask increases, which exacerbates mask doming caused by the thermal expansion of the shadow mask occurring when a high-brightness image is displayed, with the result that the color purity of a screen is likely to be degraded.

Hereinafter, the degradation in color purity in the case where mask doming occurs will be described with reference to FIGS. 14 to 16. FIG. 14 is a perspective view of a shadow mask for illustrating the overall mask doming that occurs in a conventional shadow mask. FIG. 15 is a plan view of a shadow mask for illustrating that a mislanding amount varies depending upon the incident angle of an electron beam in a conventional shadow mask. Furthermore, FIG. 16 is a perspective view of a shadow mask for illustrating mask doming that occurs locally in a conventional shadow mask.

As shown in FIG. 14, when mask doming occurs, in which a curved surface shape represented by long and short dashed lines changes to a curved surface shape represented by a broken line due to the displacement represented by arrows, an electron beam having passed through an aperture of a shadow mask 7 lands on a phosphor stripe inappropriately, which degrades color purity. Generally, in a region where the radius of curvature of a shadow mask is larger, mask doming becomes larger, and a mislanding amount also becomes larger. The mislanding amount also depends upon the incident angle of an electron beam. Therefore, as shown in FIG. 15, the mislanding amount is small in regions 11 in the vicinity of the center of the shadow mask 7 where an incident angle is small. Furthermore, assuming that the distance from the center to the X-axis end is L, in regions 12 in the vicinity of the X-axis where the distance from the Y-axis is 2 L/3 to 3 L/4, mask doming is likely to occur, and the incident angle of an electron beam becomes larger. Therefore, the mislanding amount becomes large, which causes a remarkable degradation in color purity. Furthermore, in regions 13 in the vicinity of the X-axis ends, although the incident angle of an electron beam becomes further larger, the mask doming amount becomes small. Therefore, the mislanding amount decreases, and the color purity is not so degraded. In FIG. 15, the length of thick arrows represents the magnitude of the mislanding amount.

A method is proposed for adjusting mislanding by correcting the position of a shadow mask with respect to a phosphor screen, using a spring utilizing thermal expansion of a frame or a bimetal utilizing heat transmitted from a shadow mask. According to this method, the mislanding in the regions 12 in the vicinity of the X-axis where the distance from the Y-axis is 2 L/3 to 3 L/4 and in the regions 13 in the vicinity of the X-axis ends cannot be corrected appropriately, and only the balance of each mislanding amount can be adjusted. Furthermore, in the case of displaying a high-brightness pattern in a window shape in a region in the vicinity of the X-axis where the distance from the Y-axis is 2 L/3, local mask doming (curved surface shape represented by a broken line in the figure) as shown in FIG. 16 occurs. At this time, the local heat of the shadow mask 7 is unlikely to be transmitted to the entire frame, so that correcting elements such as a spring and a bimetal do not function, and mislanding is not adjusted.

Recently, a technique of suppressing mislanding caused by mask doming, by adjusting the curved surface shape of a shadow mask is proposed.

For example, there is a technique of suppressing the occurrence of mask doming by setting a radius of curvature Rx in the X-axis direction to be relatively larger than a radius of curvature Ry in the Y-axis direction (see JP 62(1987)-168320 A, for example).

Furthermore, the following technique is proposed: assuming that the radius of curvature in the X-axis direction is Rh, and the radius of curvature in the Y-axis direction is Rv, by setting Rh on an axis parallel to an X-.axis to be larger than Rh on the X-axis as the distance from the X-axis increases, and by setting Rh on an axis parallel to a Y-axis to be larger than Rh on the Y-axis as the distance from the Y-axis increases, thereby suppressing the occurrence of mask doming (see JP 60(1985)-12649 A, for example).

Furthermore, the following technique is proposed: in a region excluding a center point on the Y-axis and two end points in the Y-axis direction, by shifting the curved surface shape in the Y-axis direction to the center side (direction opposite to the phosphor screen) from an arc determined by three points (i.e., the center point and two end points in the Y-axis direction), the radius of curvature in the Y-axis direction is decreased to suppress the occurrence of mask doming (see JP 60(1985)-9035 A, for example).

In the above-mentioned 62(1987)-168320A, mask doming is proportional to an average R of the radius of curvature Rx in the X-axis direction and the radius of curvature Ry in the Y-axis direction. Therefore, although the above-mentioned technique is effective in the case where the high-brightness pattern in a window shape is vertically oriented, the effect thereof decreases in the case where the high-brightness pattern in a window shape is square or horizontally oriented. Furthermore, in the case of using a low-transmittance panel, a flatter mask curved surface is required, which makes it difficult to obtain the shock resistance desired for a shadow mask.

Furthermore, in the above-mentioned JP 60(1985)-12649 A, although the occurrence of mask doming can be suppressed in a region in the vicinity of the center, the occurrence of mask doming cannot be suppressed in a region in the vicinity of the X-axis where the distance from the Y-axis is 2 L/3 to 3 L/4. Furthermore, in the case of using a low-transmittance panel, a flatter mask curved surface is required, which makes it difficult to obtain the shock resistance desired for a shadow mask.

In the above-mentioned JP 60(1985)-9035 A, although the above-mentioned technique has an effect of suppressing mask doming, when the radius of curvature in the Y-axis direction in the region in the vicinity of the X-axis where the distance from the Y-axis in the shadow mask is 2 L/3 to 3 L/4 is decreased, it is necessary to decrease further the radius of curvature in the Y-axis direction in the vicinity of a long side in a contour of the shadow mask. Consequently, the interval between the shadow mask and the panel inner surface increases, and the resolution is degraded. Furthermore, when an attempt is made to obtain the desired resolution, using a low-transmittance panel in which the radius of curvature in the Y-axis direction of the panel inner surface needs to be larger than that of a panel in a conventional color picture tube, the radius of curvature in the Y-axis direction of the shadow mask also needs to be increased. Therefore, the effect of suppressing mask doming decreases, and the mask curved-surface strength decreases. Furthermore, when an attempt is made to suppress the occurrence of mask doming, using a low-transmittance panel, resolution is degraded. Furthermore, the above-mentioned JP 60(1985)-9035 A only pays attention to the decrease in a radius of curvature in the Y-axis direction of a shadow mask in the same way as in the above-mentioned JP 62(1987)-168320 A. Thus, when the radius of curvature in the X-axis direction is large, even if the radius of curvature in the Y-axis direction is small, the effect of suppressing mask doming decreases depending upon the brightness pattern to be displayed on a screen.

Thus, in the conventional technique, particularly, in the case of using a low-transmittance panel in which the radius of curvature in the Y-axis direction of the panel inner surface needs to be large, one or more of the color purity, mask shock resistance, and resolution is impaired.

### SUMMARY OF THE INVENTION

Therefore, with the foregoing in mind, it is an object of the present invention to provide a color picture tube without any of color purity, mask shock resistance, and resolution being impaired remarkably, in the case of using a low-transmittance panel in which a radius of curvature in a Y-axis direction of a panel inner surface needs to be larger than that of a panel in a conventional color picture tube. It is another object of the present invention to provide a color picture tube in which mask shock resistance is enhanced while resolution and color purity equal to those of a conventional example are obtained, in the case of using a panel whose radius of curvature of a panel inner surface is equal to that of a conventional example.

According to the present invention, in order to achieve the above-mentioned object, in a color picture tube, the curved surface shape of a shadow mask is adjusted, paying attention to the points that mask curved-surface strength depends upon a minimum radius of curvature, and mask doming depends upon an average radius of curvature between a maximum radius of curvature and a minimum radius of curvature in the mask curved surface.

A color picture tube according to the present invention includes a panel having an outer surface with a radius of curvature of 10,000 mm or more, a funnel connected to the panel, a phosphor screen provided on an inner surface of the panel, an electron gun provided in the funnel, and a shadow mask provided in the panel so as to be opposed to the phosphor screen and having a substantially rectangular perforated curved-surface portion with a plurality of apertures.

It is assumed that an axis in a long side direction of the perforated curved-surface portion, which passes through a center of the perforated curved-surface portion, is an X-axis, an axis in a short side direction of the perforated curved-surface portion, which passes through the center, is a Y-axis, a length from the center to an end portion on the X-axis of the perforated curved-surface portion is Lₓ, a length from the center to an end portion on the Y-axis of the perforated curved-surface portion is L_{Y}, a radius of curvature in a radial direction of the perforated curved-surface portion at an arbitrary point (X, Y) of the perforated curved-surface portion is Rᵣ(X, Y) and a radius of curvature in a direction vertical to the radial direction of the perforated curved-surface portion is R₁(X, Y), and a main radius of curvature group consists of a maximum radius of curvature and a minimum radius of curvature at the arbitrary point (X, Y) of the perforated curved-surface portion.

At an arbitrary point on the X-axis and the Y-axis, Rᵣ(X, Y) is one radius of curvature of the main radius of curvature group, and R₁(X, Y) is the other radius of curvature of the main radius of curvature group (Condition A1).

On the Y-axis, |Rᵣ(0, Y)|<|R₁(0, Y) I is satisfied at an arbitrary point in a range where a distance from the center is L_{Y} or less (Condition A2).

On the X-axis, |Rᵣ(X, 0)|>|R₁(X, 0)| is satisfied at an arbitrary point in a range where the distance from the center is Lₓ/3 or less (Condition A3). |Rᵣ(X, 0)|<|R₁(X, 0)| is satisfied at an arbitrary point in a range where the distance from the center is 3 Lₓ/4 to Lₓ (Condition A4).

In the present invention, the term “arbitrary” means that a predetermined condition is satisfied with respect to any point or value in a prescribed region or range.

### BRIEF DESCRIPTION OF THE DRAWINGS

FIG. 1 is a schematic cross-sectional view showing an overall configuration of a color picture tube according to Embodiment 1 of the present invention.

FIG. 2 is a schematic perspective view showing an overall configuration of a shadow mask according to Embodiment 1 of the present invention.

FIG. 3 is a graph showing an exemplary change along a Y-axis in a radius of curvature |Rᵣ| in a radial direction and in a radius of curvature |R₁| in a direction vertical to the radial direction in a perforated curved-surface portion of the shadow mask according to Embodiment 1 of the present invention.

FIG. 4 is a graph showing an exemplary change along an X-axis in a radius of curvature |Rᵣ| in a radial direction and in a radius of curvature |R₁| in a direction vertical to the radial direction in the perforated curved-surface portion of the shadow mask according to Embodiment 1 of the present invention.

FIG. 5 is a graph showing an exemplary change along a D₁-axis in a radius of curvature |Rᵣ| in a radial direction and in a radius of curvature |R₁| in a direction vertical to the radial direction in the perforated curved-surface portion of the shadow mask according to Embodiment 1 of the present invention.

FIG. 6 is a graph showing an exemplary change in an average radius of curvature Rₐ along an X-axis in the perforated curved-surface portion of the shadow mask according to Embodiment 1 of the present invention.

FIG. 7 is a graph showing a mask displacement amount with respect to a pressure amount according to a simulation of static pressure buckling strength in Embodiment 1 of the present invention.

FIG. 8 is a graph showing a buckling critical pressure amount with respect to the radius of curvature |Rᵣ| in the radial direction in Embodiment 1 of the present invention.

FIG. 9 is a graph showing a landing error with respect to the average radius of curvature Rₐ according to a simulation in Embodiment 1 of the present invention.

FIG. 10 is a view illustrating a main radius of curvature group at an arbitrary point of the perforated curved-surface portion.

FIG. 11 is a view illustrating a condition of a change in a radius of curvature along an axis parallel to a Y-axis in a perforated curved-surface portion of a shadow mask according to Embodiment 2 of the present invention.

FIG. 12 is a graph showing a change in a radius of curvature |R₁| along a Y_{XA}-axis in the perforated curved-surface portion of the shadow mask according to Embodiment 2 of the present invention.

FIG. 13 is a graph showing a change in a radius of curvature |R₁| along a Y_{XB}-axis in the perforated curved-surface portion of the shadow mask according to Embodiment 2 of the present invention.

FIG. 14 is a perspective view of a shadow mask for illustrating overall mask doming in a conventional shadow mask.

FIG. 15 is a plan view of a shadow mask for illustrating a mislanding amount in a conventional shadow mask.

FIG. 16 is a perspective view of a shadow mask for illustrating local mask doming in a conventional shadow mask.

### DETAILED DESCRIPTION OF THE INVENTION

According to the present invention, in the case of using a low-transmittance panel in which the radius of curvature in a Y-axis direction of a panel inner surface needs to be larger than that of a conventional panel, color purity, mask shock resistance, and resolution equal to those of a conventional color picture tube can be realized. Herein, the “low-transmittance panel” refers to a panel made of a tinted glass material in which the transmittance of light with a wavelength of 546 nm in a thickness of 10.16 mm (0.400 inches) is less than 60%.

Furthermore, according to the present invention, in the case of using a panel whose radius of curvature of a panel inner surface is equal to that of a conventional example, color purity and resolution equal to those of a conventional color picture tube are obtained, and mask shock resistance can be enhanced.

As described above, a color picture tube of the present invention includes a panel with a substantially flat outer surface, a funnel, a phosphor screen, an electron gun, and a shadow mask having a perforated curved-surface portion with a plurality of apertures and a curved surface shape satisfying the above conditions A1 to A4. In the following, Rᵣ(X, Y) and R₁(X, Y) will be abbreviated as Rᵣ and R₁, respectively, unless any misunderstanding is caused.

In the case of using a low-transmittance panel, in order to alleviate the difference between the darkness in the screen center and the darkness at the Y-axis end portion, an entire radius of curvature in a Y-axis direction becomes larger than that of a conventional panel. When the radius of curvature in the Y-axis direction of a shadow mask is simply increased over the entire Y-axis in accordance with a panel, the mask curved-surface strength is degraded. However, by minimizing |Rᵣ| at an end portion in the Y-axis direction (hereinafter, referred to as a “Y-axis end portion”) of the perforated curved-surface portion in a range where the resolution of the Y-axis end portion is not degraded, the degradation in mask curved-surface strength can be minimized. Furthermore, it is preferable that |Rᵣ| at the Y-axis end portion is a minimum radius of curvature, since its effect becomes high. Furthermore, by minimizing |Rᵣ| at an end portion in an X-axis direction (hereinafter, referred to as an “X-axis end portion”) of the perforated curved-surface portion in a range where the resolution of the X-axis end portion is not degraded, the mask curved-surface strength can be supplemented. Furthermore, it is preferable that |Rᵣ| at the X-axis end portion is a minimum radius of curvature, since its effect becomes high. The mask curved-surface strength can be maintained equal to that of a conventional example by optimizing |Rᵣ| at the Y-axis end portion and |Rᵣ| at the X-axis end portion.

Furthermore, |R₁| can be increased at the Y-axis end portion and the X-axis end portion without degrading the mask curved-surface strength, so that |R₁| at an end portion in a D-axis (described later) direction (point where a long side and a short side of the perforated curved-surface portion cross each other; hereinafter, referred to as a “D-axis end portion”) of the perforated curved-surface portion can be set to be smaller than |Rᵣ|. The mask curved-surface strength at the D-axis end portion is determined by |R₁|. Therefore, by increasing |Rᵣ|, the increase in the sagging amount at the D-axis end portion can be suppressed, and the resolution equal to that of a conventional example can be maintained.

The above-mentioned condition A1 means that, among radii of curvature including Rᵣ and R₁ at an arbitrary point on the X-axis, one of Rᵣ and R₁ is a maximum radius of curvature, and the other is a minimum radius of curvature. The same condition is satisfied even with respect to an arbitrary point on the Y-axis. Furthermore, it is preferable that the same condition is satisfied even with respect to an arbitrary point on the D-axis.

The above-mentioned condition A2 may be satisfied on the Y-axis. However, it is preferable that the same condition is satisfied on an arbitrary axis parallel to the Y-axis where the distance from the center is more than 0 and less than Lₓ/10.

Furthermore, the above conditions A3 and A4 may be satisfied on the X-axis. However, it is preferable that the same condition is satisfied on an arbitrary axis parallel to the X-axis where the distance from the X-axis is more than 0 and less than L_{Y}/10.

It is assumed that a plane including a tube axis and a point where a long side and a short side of the perforated curved-surface portion cross each other is a diagonal plane, an axis that is included in this diagonal plane, passes through a center of the perforated curved-surface portion, and is vertical to the tube axis is a D-axis, and the length from the center to an end portion on the D-axis of the perforated curved-surface portion is L_{D}. In the color picture tube of the present invention, it is preferable that, on the D-axis, at an arbitrary point in a range where the distance from the center is L_{D}/3 or less, |Rᵣ(X, Y)|>|R₁(X, Y)| is satisfied (Condition B1), and at an arbitrary point in a range where the distance from the center is 3 L_{D}/4 to L_{D}, |Rᵣ(X, Y)|>|R₁(X, Y)| is satisfied (Condition B2).

It is assumed that an average between |Rᵣ(X, Y)| and |R₁(X, Y)| at an arbitrary point (X, Y) of the perforated curved-surface portion is Rₐ(X, Y). In the color picture tube according to the present invention, it is preferable, that Rₐ(X, Y) on the X-axis takes a minimum value in a range where the distance from the center is Lₓ/2 to 9 Lₓ/10 (Condition C1). In a range on the X-axis where the mislanding amount caused by mask doming of the perforated curved-surface portion is likely to increase and the distance from the center is Lₓ/2 to 9 Lₓ/10, Rₐ is smaller than that in the other range on the X-axis, so that the mislanding amount caused by mask doming in the vicinity of the X-axis can be decreased. It is further preferable that Rₐ on the X-axis takes a minimum value in a range where the mislanding amount is largest and the distance from the center is 2 Lₓ/3 to 3 Lₓ/4. Furthermore, the above-mentioned condition C1 may be satisfied on the X-axis. However, it is preferable that the same condition is satisfied on an arbitrary axis parallel to the X-axis where the distance from the X-axis is more than 0 and less than L_{Y}/10. In the following, Rₐ(X, Y) also will be abbreviated as Rₐ, unless any misunderstanding is caused.

It is assumed that an average value of Rₐ(X, 0) on the X-axis in the vicinity of the center is R_{ac}, an average value of Rₐ(X, 0) on the X-axis in a range where the distance from the center is 2 Lₓ/3 to 3 Lₓ/4 is Rₐₘ, and an average value of Rₐ(X, 0) on the X-axis in the vicinity of an end portion on the X-axis is Rₐₑ. In the color picture tube according to the present invention, it is preferable to satisfy R_{ac}>Rₐₘ<Rₐₑ (Condition C2). This can suppress further the occurrence of mask doming in the vicinity of the X-axis. Furthermore, the above-mentioned condition C2 may be satisfied on the X-axis. However, it is preferable that the same condition is satisfied on an arbitrary axis parallel to the X-axis where the distance from the X-axis is more than 0 and less than L_{Y}/10. The “vicinity of the center on the X-axis” means a range where the distance from the center on the X-axis is less than Lₓ/10, and the “vicinity of the end portion on the X-axis” means a range where the distance from the center on the X-axis is more than 9 Lₓ/10 and less than Lₓ.

It is assumed that an axis that passes through a point (X_{A}, 0) on the X-axis where the distance from the center is an arbitrary distance X_{A} of Lₓ/2 to 9 Lₓ/10, and is parallel to the Y-axis is a Y_{XA}-axis, and an axis that passes through a point (X_{B}, 0) on the X-axis where the distance from the center is an arbitrary distance X_{B} of 0 to Lₓ/2, and is parallel to the Y-axis is a Y_{XB}-axis. In the color picture tube according to the present invention, it is preferable that a function representing a change in |R₁(X_{A}, Y)| with respect to the distance from the point (X_{A}, 0) along the Y_{XA}-axis takes a maximum value in a range where the distance from the point (X_{A}, 0) is more than L_{Y}/5 and less than L_{Y}/2. Furthermore, it is preferable that a function representing a change in |R₁(X_{B}, Y)| with respect to the distance from the point (X_{B}, 0) along the Y_{XB}-axis takes a maximum value in a range where the distance from the point (X_{B}, 0) is more than L_{Y}/2 and less than 4 L_{Y}/5. This can set |R₁| on the D-axis to be small. Therefore, |Rᵣ| on the D-axis is increased, and with respect to the perforated curved-surface portion in a curved surface shape with high flatness, the mask curved-surface strength can be enhanced while a mislanding amount caused by mask doming in the vicinity of the D-axis is suppressed.

It is assumed that an average value of |R₁(X_{A}, Y)| in the vicinity of an intersection between the X-axis and the Y_{XA}-axis is R₁ₓ, an average value of |R₁(X_{A}, Y)| on the Y_{XA}-axis in a range where the distance from the X-axis is more than L_{Y}/5 and less than L_{Y}/2 is R₁ₘₓ, an average value of |R₁(X_{A}, Y)| in the vicinity of an intersection between the D-axis and the Y_{XA}-axis is R_{1d}, an average value of |R₁(X_{B}, Y)| in the vicinity of an intersection between the D-axis and the Y_{XB}-axis is R_{1d′}, an average value of |R₁(X_{B}, Y)| on the Y_{XB}-axis in a range where the distance from the X-axis is more than L_{Y}/2 and less than 4 L_{Y}/5 is R₁ₘₑ, and an average value of |R₁(X_{B}, Y)| in the vicinity of an end portion on the Y_{XB}-axis of the perforated curved-surface portion is R₁ₑ. In the color picture tube according to the present invention, it is preferable that R₁ₓ<R₁ₘₓ>R_{1d} is satisfied, and R_{1d′}<R₁ₘₑ>R₁ₑ is satisfied. Because of this, |Rᵣ| on the D-axis is increased, and with respect to the perforated curved-surface portion in a curved surface shape with high flatness, the mask curved-surface strength can be enhanced while the occurrence of mask doming is suppressed. The “vicinity of the intersection between the X-axis and the Y_{XA}-axis” generally means a region on the Y_{XA}-axis in a range where the distance from the intersection along the Y_{XA}-axis is less than L_{Y}/10, and the “vicinity of the intersection between the D-axis and the Y_{XA}-axis” generally means a region on the Y_{XA}-axis in a range where the distance from the intersection along the Y_{XA}-axis is less than L_{Y}/10. Furthermore, the “vicinity of the intersection between the D-axis and the Y_{XB}-axis” generally means a region on the Y_{XB}-axis in a range where the distance from the intersection along the Y_{XB}-axis is less than L_{Y}/10, and the “vicinity of the end portion on the Y_{XB}-axis” generally means a region on the Y_{XB}-axis where the distance from the X-axis is 9 L_{Y}/10 to L_{Y}.

### Embodiment 1

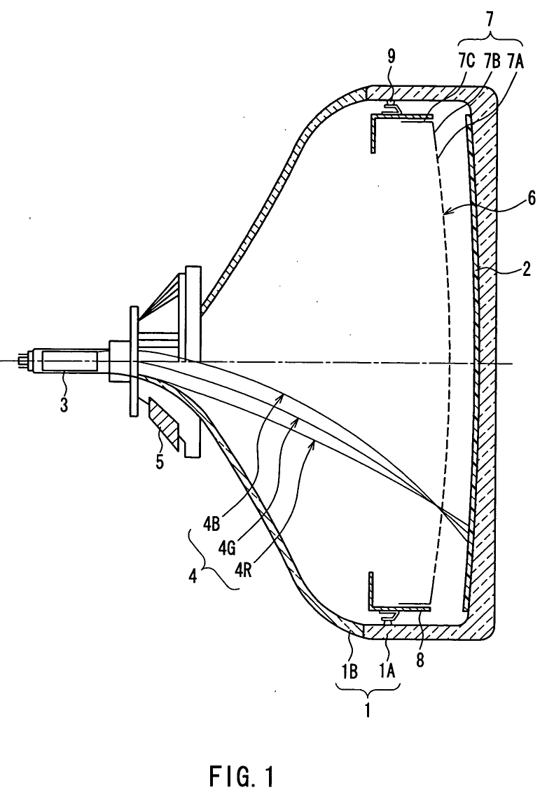

In Embodiment 1, a color picture tube according to the present invention will be described with reference to FIGS. 1 to 11. The case will be exemplified in which a screen of the color picture tube has an aspect ratio of 16:9 and a diagonal useful size of 66 cm.

FIG. 1 is a schematic cross-sectional view showing an overall configuration of the color picture tube. The color picture tube shown in FIG. 1 includes a bulb 1 having a panel 1A and a funnel 1B, a phosphor screen 2 provided on an inner surface of the panel 1A, an electron gun 3 provided in the funnel 1B, and a shadow mask 7 provided in the panel 1A so as to be opposed to the phosphor screen 2 and having a plurality of slits (apertures) 6 through which an electron beam 4 passes. At the outer edge of the funnel 1B, a deflection yoke 5 deflecting the electron beam 4 from the electron gun 3 is provided.

An outer surface of the panel 1A has a radius of curvature of 10,000 mm or more, is substantially flat, and is excellent in visibility. Herein, the “radius of curvature of the outer surface of the panel 1A” refers to a radius of an arc defined by the center of a substantially rectangular useful display area on the outer surface of the panel 1A and a pair of diagonal axis ends sandwiching the center.

The phosphor screen 2 has three kinds of stripe-shaped phosphor layers oriented parallel to a vertical direction for red emission, green emission, and blue emission. The electron gun 3 generates three electron beams: an electron beam 4R that allows the phosphor layer for red emission to emit light, an electron beam 4G that allows the phosphor layer for green emission to emit light, and an electron beam 4B that allows the phosphor layer for blue emission to emit light. The configuration of the color picture tube of Embodiment 1 is substantially the same as that of a known color picture tube, expect for the configuration of the shadow mask 7. Therefore, in the following, only the shadow mask 7 will be described in detail.

As shown in FIG. 1, the shadow mask 7 is fixed onto a rectangular frame 8 at a skirt portion 7C on the periphery of the shadow mask 7. Furthermore, the frame 8 is supported by the panel 1A via a support member 9 so that the shadow mask 7 keeps a predetermined interval with respect to the inner surface of the panel 1A.

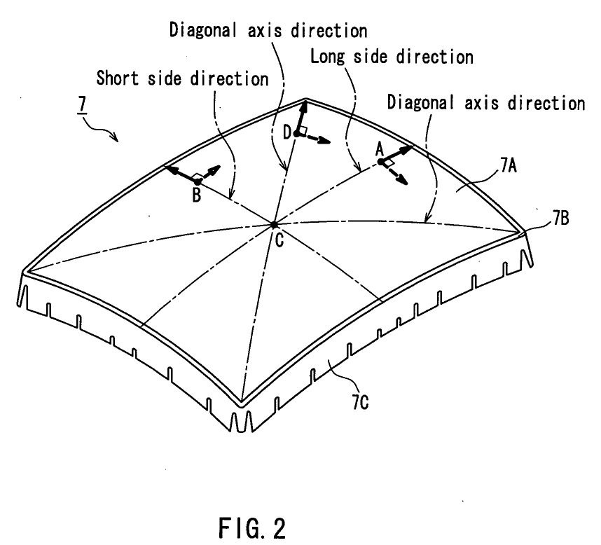

FIG. 2 is a schematic perspective view showing an overall configuration of the shadow mask. As shown in FIG. 2, the shadow mask 7 is composed of a substantially rectangular perforated curved-surface portion 7A with a plurality of slits 6 (see FIG. 1) through which an electron beam passes, a non-perforated curved-surface portion 7B without the slits 6 on the periphery of the perforated curved-surface portion 7A, and a skirt portion 7C formed at an outer edge of the non-perforated curved-surface portion 7B. The plate thickness in the perforated curved-surface potion 7A is substantially uniform. The shadow mask 7 can be produced, for example, by pressing a flat mask obtained by subjecting an Invar material (nickel (30-50 wt %)—ion alloy) or an iron material (aluminum killed material) with a plate thickness of 0.22 to 0.25 mm to etching treatment to form the slits 6.

It is assumed that a center of the shadow mask 7, which crosses the tube axis of the color picture tube, is an origin (point C in FIG. 2), an axis in a long side direction vertical to the tube axis is an X-axis, and an axis (axis vertical to the tube axis and the X-axis) in a short side direction vertical to the tube axis is a Y-axis. It is assumed that a direction directed from the origin C to a point A is a positive direction, and a direction directed from the origin C to a point B is a positive direction of the Y-axis. It is assumed that a point where the long side and the short side of the substantially rectangular perforated curved-surface portion 7A cross each other is a diagonal axis end portion (D-axis end portion), and a plane including the diagonal axis end portion and the tube axis is a diagonal plane. It is assumed that an axis that is included in the diagonal plane, passes through the origin C, and is vertical to the tube axis is a D-axis. It is assumed that four D-axes are present so as to correspond to four diagonal axis end portions, and the D-axes respectively present in first to fourth quadrants are a D₁-axis to a D₄-axis in this order. The direction directed from the origin C to a point D present in the first quadrant is a positive direction of the D₁-axis.

In FIG. 2, radial directions with respect to the points A, B, and D on the perforated curved-surface portion 7A are represented by solid arrows, and directions vertical to the radial directions with respect to these points are represented by broken arrows. The radial direction with respect to the point A is parallel to the X-axis, and the direction vertical to the radial direction with respect to the point A is parallel to the Y-axis. Similarly, the radial direction with respect to the point B is parallel to the Y-axis, and the direction vertical to the radial direction with respect to the point B is parallel to the X-axis. Furthermore, the radial direction with respect to the point D is parallel to the D₁-axis, and the direction vertical to the radial direction with respect to the point D is vertical to both the tube axis and the D₁-axis.

Herein, since the perforated curved-surface portion 7A has a curved surface shape, a point (X′, Y′) on the perforated curved-surface portion 7A is different from a point (X, Y) in an X-Y coordinate system with the X-axis and the Y-axis being coordinate axes. Strictly, a position at which the point (X, Y) is projected onto the perforated curved-surface portion 7A along the tube axis direction corresponds to the point (X′, Y′). However, in the present specification, for simplicity of description, the point (X′, Y′) is assumed to be the same as that of the point (X, Y).

A radius of curvature Rᵣ (X, Y) in the radial direction means the radius of curvature at the point (X, Y) with respect to an intersection line between the surface of the perforated curved-surface portion 7A and a radial direction plane (i.e., a plane that includes a straight line connecting the point (X, Y) to the origin (0,0) and the tube axis). Furthermore, a radius of curvature R₁ (X, Y) in a direction vertical to the radial direction means the radius of curvature at the point (X, Y) with respect to an intersection line between the surface of the perforated curved-surface portion 7A and an orthogonal plane (i.e., a plane that is orthogonal to a plane including a straight line connecting the point (X, Y) to the origin (0,0) and the tube axis, includes the point (X, Y), and is parallel to the tube axis).

The mask curved-surface strength at an arbitrary point (X, Y) of the perforated curved-surface portion 7A is determined by a minimum radius of curvature at that point. Herein, the minimum radius of curvature and the maximum radius of curvature will be described with reference to FIG. 10. FIG. 10 is a view illustrating a main radius of curvature group at an arbitrary point in the perforated curved-surface portion 7A. The radius of curvature at a point E with respect to a curve formed by the surface of the perforated curved-surface portion 7A in a cross-section along a plane including a straight line 17 that is parallel to the tube axis and includes the point E will be considered. The radius of curvature at the point E varies depending upon the direction of the plane. Among these radii of curvature, the minimum radius of curvature will be referred to as a minimum radius of curvature at the point E, and the maximum radius of curvature will be referred to as a maximum radius of curvature at the point E. In FIG. 10, the radius of curvature in a direction 16 represented by a solid arrow is a maximum radius of curvature, and the radius of curvature in a direction 15 represented by a broken arrow is a minimum radius of curvature.

Hereinafter, the curved surface shape of the perforated curved-surface portion 7A will be described in detail by way of one example. The curved surface shape of the perforated curved-surface portion 7A is symmetric with respect to a plane including the tube axis and the X-axis, and is symmetric with respect to a plane including the tube axis and the Y-axis. Thus, hereinafter, for simplicity of description, only the curved surface shape in the first quadrant on an X-Y coordinate system will be described.

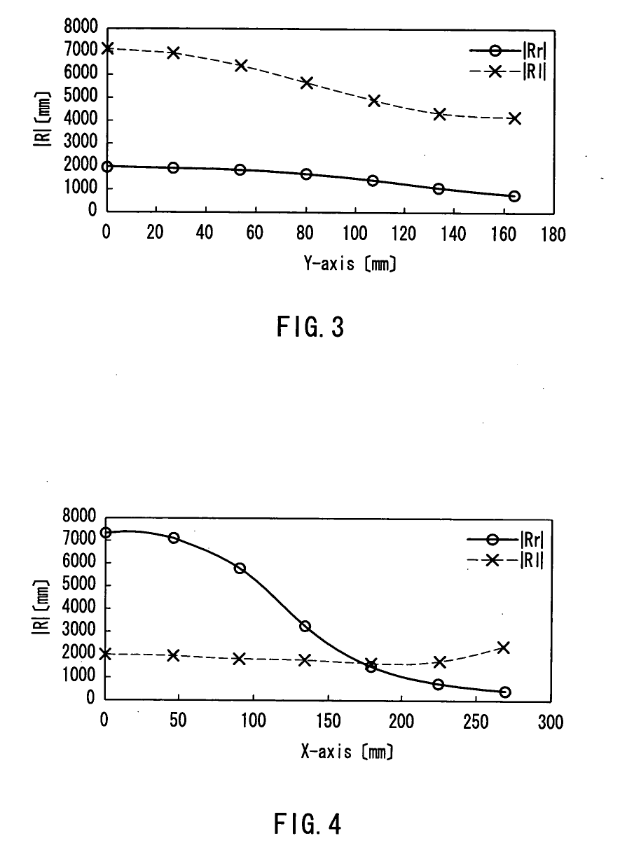

FIG. 3 is a graph showing an exemplary change in the radius of curvature |Rᵣ| along the Y-axis in a radial direction of the perforated curved-surface portion 7A and an exemplary change in the radius of curvature |R₁| along the Y-axis in a direction vertical to the radial direction. In FIG. 3, a graph showing a change in |Rᵣ| is represented by a solid line, and a graph showing a change in |R₁| is represented by a broken line. Furthermore, a circle mark represents a measured point of |Rᵣ|, and an X mark represents a measured point of |R₁|.

As shown in FIG. 3, |Rᵣ|<|R₁| is satisfied at an arbitrary point on the Y-axis satisfying 0≦Y≦L_{Y} (in FIG. 3, L_{Y} corresponds to 165 [mm]).

In a range from the origin (point C in FIG. 2) to the Y-axis end portion, the entire |Rᵣ| on the Y-axis becomes larger than a conventional example, owing to the use of a low-transmittance panel. When the radius of curvature in the Y-axis direction of a shadow mask is simply increased over the entire Y-axis in accordance with a panel inner surface radius of curvature, although the mask curved-surface strength is degraded, by decreasing |Rᵣ| at the Y-axis end portion, the degradation in the mask curved-surface strength can be minimized. However, if |Rᵣ| at the Y-axis end portion is set to be too small, it is necessary to increase the pitch of the slits 6 of the shadow mask 7, which may decrease resolution. Thus, by setting |Rᵣ| to be large in a range from the center to the vicinity of ⅔ L_{Y} to ¾ L_{Y} on the Y-axis, where the influence on the mislanding amount caused by mask doming and the mask curved-surface strength is small, and setting |Rᵣ| to be small in a range on the Y-axis end portion side from the above range so that the resolution at the Y-axis end portion becomes substantially equal to that in the vicinity of the origin, the mask curved-surface strength can be maintained while the sagging amount at the Y-axis end portion is suppressed.

On the other hand, at the Y-axis end portion, a value about 5 to 6 times |Rᵣ| is selected as |R₁|. In one example shown in FIG. 3, at the Y-axis end portion, |Rᵣ| is 700 [mm], and |R₁| is 4200 [mm]. By setting |R₁| at the Y-axis end portion to be large, the sagging amount at the D-axis end portion can be suppressed.

FIG. 4 is a graph showing an exemplary change in the radius of curvature |Rᵣ| along the X-axis in the radial direction of the perforated curved-surface portion 7A and an exemplary change in the radius of curvature |R₁| along the X-axis in a direction vertical to the radial direction. In FIG. 4, a graph showing a change in |Rᵣ| is represented by a solid line, and a graph showing a change in |R₁| is represented by a broken line. Furthermore, a circle mark represents a measured point of |Rᵣ|, and an X mark represents a measured point of |R₁|.

As shown in FIG. 4, at an arbitrary point in a region on the X-axis satisfying 0≦X≦Lₓ/3 (in FIG. 4, Lₓ/3 corresponds to 95 [mm]) (hereinafter, referred to as a “center region on the X-axis”), |Rᵣ|>|R₁| is satisfied. Furthermore, at an arbitrary point in a region on the X-axis satisfying 3 Lₓ/4≦X≦Lₓ (in FIG. 4, 3 Lₓ/4 corresponds to 213 [mm], and Lₓ corresponds to 284 [mm]) (hereinafter, referred to as a “peripheral region on the X-axis”), |Rᵣ|<|R₁| is satisfied.

By setting |R₁| at the X-axis end portion to be large, the sagging amount at the D-axis end portion can be suppressed, and by setting |Rᵣ| at the X-axis end portion to be small, the mask curved-surface strength can be maintained. However, if |Rᵣ| at the X-axis end portion is set to be too small, the resolution at the X-axis end portion is degraded in the same way as in the case of the Y-axis end portion. Thus, by selecting a smallest value at which intended resolution is obtained at the X-axis end portion, as |Rᵣ| at the X-axis end portion, the degradation in resolution is minimized while the mask curved-surface strength is kept.

On the other hand, |Rᵣ| in the center region on the X-axis has a small influence on the mislanding amount caused by mask doming and the mask curved-surface strength, so that a largest possible value is selected as |Rᵣ|. Because of this, the sagging amount at the X-axis end portion can be suppressed while |Rᵣ| at the X-axis end portion can be set to be small.

At the X-axis end portion, a value about 5 to 6 times |Rᵣ| is selected as |R₁|. In one example shown in FIG. 4, at the X-axis end portion, |Rᵣ| is 400 [mm], and |R₁| is 2300 [mm].

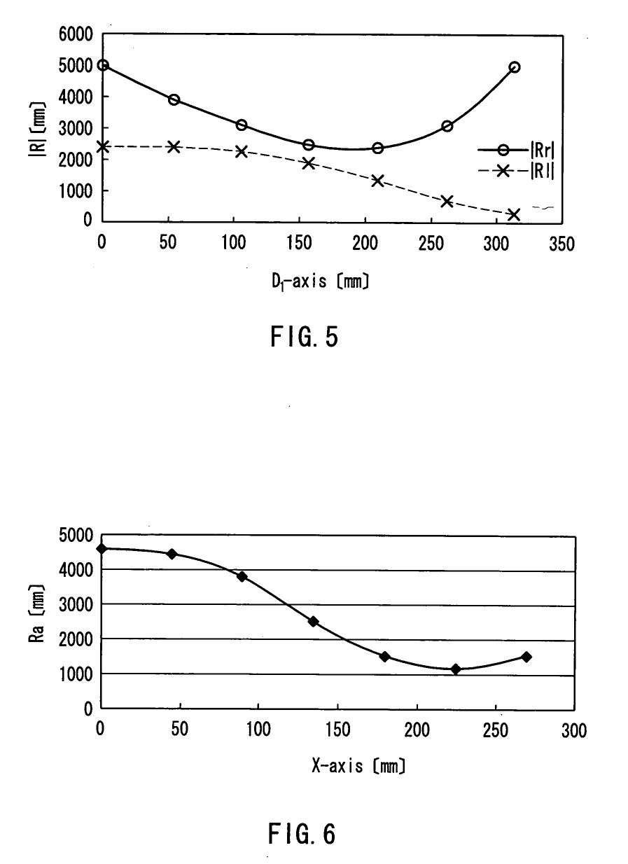

FIG. 5 is a graph showing an exemplary change in a radius of curvature |Rᵣ| along the D₁-axis in the radial direction of the perforated curved-surface portion 7A, and an exemplary change in a radius of curvature |R₁| along the D₁-axis in a direction vertical to the radial direction. In FIG. 5, a graph showing a change in |Rᵣ| is represented by a solid line, and a graph showing a change in |R₁| is represented by a broken line. Furthermore, a circle mark represents a measured point of |Rᵣ|, and an X mark represents a measured point of |R₁|.

Assuming that the distance from the origin (point C in FIG. 2) along the D₁-axis is D, as shown in FIG. 5, |Rᵣ|>|R₁| is satisfied at an arbitrary point in a region on the D₁-axis satisfying 0≦D≦L_{D}/3 (in FIG. 5, L_{D}/3 corresponds to 106 [mm]) (hereinafter, referred to as a “center region on the D₁-axis”). Furthermore, |Rᵣ|>|R₁| is satisfied at an arbitrary point in a region on the D₁-axis satisfying 3 L_{D}/4≦D≦L_{D} (in FIG. 5, 3 Lₓ/4 corresponds to 239 [mm], and L_{D} corresponds to 319 [mm]) (hereinafter, referred to as a “peripheral region on the D₁-axis”).

As described above, by setting |R₁| at the Y-axis end portion and |R₁| at the X-axis end portion to be about 5 to 6 times |Rᵣ| at the Y-axis end portion and |Rᵣ| at the X-axis end portion, |R₁| can be set to be small on the D₁-axis. On the D₁-axis, since |Rᵣ| can be set to be larger than |R₁|, the sagging amount at the D₁-axis end portion can be reduced, and the intended resolution at the D₁-axis end portion can be obtained. On the D₁-axis, even when |Rᵣ| is set to be large, |R₁| can be set to be sufficiently small, so that the mask curved-surface strength is not degraded. Furthermore, by setting the radius of curvature in the direction orthogonal to the D₁-axis to be small, the further enhancement of the mask curved-surface strength can be expected. In one example shown in FIG. 5, at the D₁-axis end portion, |Rᵣ| is 5000 [mm], and |R₁| is 300 [mm].

In the case where the perforated curved-surface portion 7A is formed in a curved surface shape with higher flatness, by further increasing the magnification of |R₁| with respect to |Rᵣ| at the X-axis end portion and the magnification of |R₁| with respect to |Rᵣ| at the Y-axis end portion, intended resolution can be obtained at the D₁-axis end portion, and by setting |R₁| at the D₁-axis end portion to be smaller, the mask curved-surface strength can be maintained.

FIG. 6 is a graph showing a change in an average radius of curvature Rₐ along the X-axis in the perforated curved-surface portion 7A. In FIG. 6, a graph of Rₐ is represented by a solid line, and a diamond mark represents a measured value. In one example shown in FIG. 6, on the X-axis, Rₐ decreases monotonically along with the increase in X to take a minimum value, and increases monotonically after taking the minimum value.

As shown in FIG. 6, in a region on the X-axis satisfying Lₓ/2≦X≦9 Lₓ/10 (in FIG. 6, Lₓ/2 corresponds to 142 [mm], and 9 Lₓ/10 corresponds to 256 [mm]), the graph of Rₐ takes a minimum value. In one example shown in FIG. 6, Rₐ on the X-axis-takes a minimum value at a point satisfying X=225 [mm], and its value is 1100 [mm].

Each |Rᵣ| at the X-axis end portion, the Y-axis end portion, and the D₁-axis end portion can be adjusted with reference to the results obtained by simulating static pressure buckling strength in a simple model in which a radius of curvature at only the contour of the perforated curved-surface portion 7A is changed. In the simulation of the static pressure bucking strength, the entire perforated curved-surface portion 7A is pressed equally, and the pressure amount is increased gradually, whereby the pressure amount at which the perforated curved-surface portion 7A buckles is simulated.

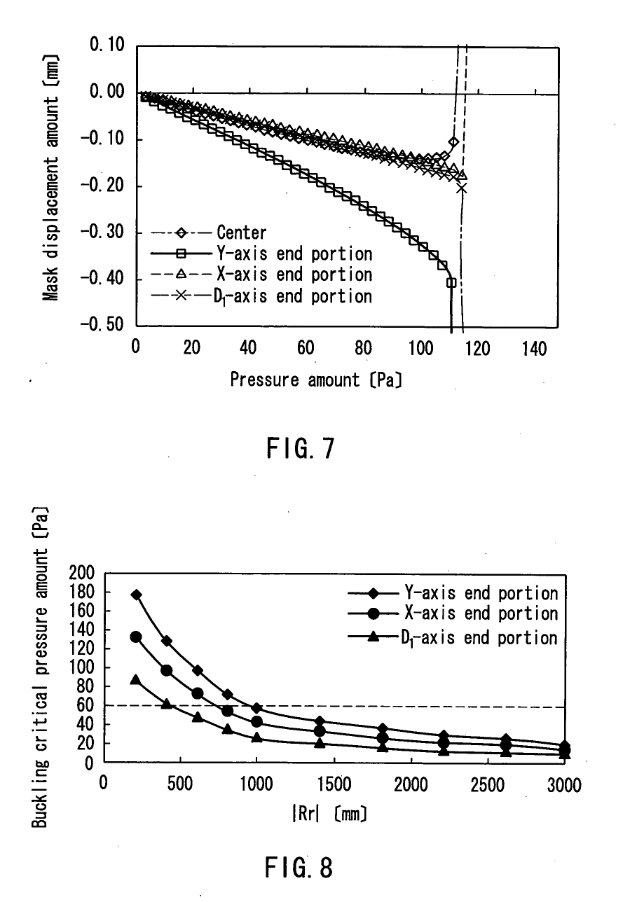

FIG. 7 is a graph showing the relationship between the pressure amount and the mask displacement amount according to the simulation of the static pressure buckling strength. In FIG. 7, a diamond mark and alternate long and short dashed lines represent a mask displacement amount at the center, a square mark and a solid line represent a mask displacement amount at the Y-axis end portion, a triangle mark and a broken line represent a mask displacement amount at the X-axis end portion, and an X mark and a chain double-dashed line represent a mask displacement amount at the D₁-axis end portion.

As shown in FIG. 7, when the pressure amount is increased gradually, the perforated curved-surface portion 7A also is displaced gradually. When the pressure amount reaches a limit, the perforated curved-surface portion 7A buckles, and the mask displacement amount increases rapidly. The pressure amount immediately before the perforated curved-surface portion 7A is displaced rapidly (hereinafter, referred to as a “buckling critical pressure amount”) is the mask curved-surface strength. When the buckling critical pressure amount is larger, the mask curved-surface strength becomes larger.

FIG. 8 is a graph showing a bucking critical pressure amount with respect to the radius of curvature |Rᵣ| in the radial direction. In FIG. 8, a diamond mark represents a measured point at the Y-axis end portion, a circle mark represents a measured point at the X-axis end portion, and a triangle mark represents a measured point at the D₁-axis end portion.

The mask curved-surface strength according to the static pressure buckling strength simulation, which generally should be sufficient to withstand the production and the practical use as a product, is considered to be 60 Pa (pascals) or more for a 66 cm class product. In the case where the mask curved-surface strength is less than 60 Pa, the perforated curved-surface portion 7A is likely to be deformed in a heating step during production and a transportation step, which also makes the production difficult. Considering that there is a possibility of the application of unexpected shock, it is desirable to maintain a mask curved-surface strength of 80 Pa or more.

As shown in FIG. 8, according to the static pressure buckling strength simulation, |Rᵣ| where the mask curved-surface strength of 60 Pa (broken line in the figure) or more is obtained, which can withstand practical use, is about 1000 [mm] or less at the Y-axis end portion, about 750 [mm] or less at the X-axis end portion, and about 500 [mm] or less at the D₁-axis end portion. Although the relationship between the radius of curvature |Rᵣ| in the radial direction and the mask curved-surface strength has been described, the same relationship holds qualitatively even with respect to the radius of curvature |R₁| in a direction vertical to the radial direction. Thus, in the end portion of each axis, at least one of |Rᵣ| and |R₁| is set to be a radius of curvature where the mask curved-surface strength becomes 60 Pa or more. In one example shown in FIGS. 3 to 5, |Rᵣ| at the Y-axis end portion is set to be 700 [mm], |Rᵣ| at the X-axis end portion is set to be 400 [mm], and |R₁| at the D₁-axis end portion is set to be 300 [mm], whereby the mask curved-surface strength of 60 Pa or more is kept.

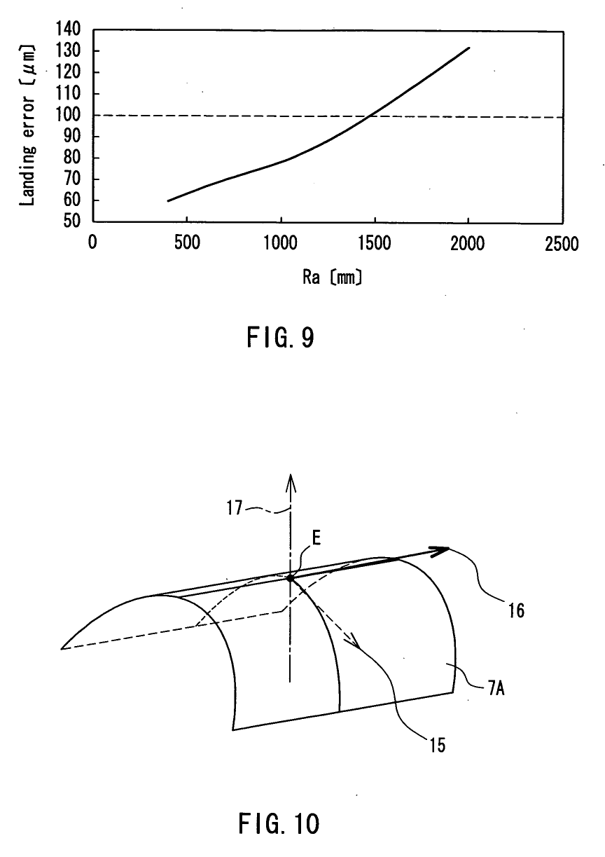

Ra on the X-axis is adjusted with reference to the results of the landing error simulation in the case where only Rₐ in a region satisfying 2 Lₓ/3≦X≦3 Lₓ/4 on the X-axis (hereinafter, referred to as an “intermediate region on the X-axis”) is changed. In the landing error simulation, mask doming caused by thermal expansion when the temperature of the perforated curved-surface portion 7A increases is simulated, and a landing error amount (mislanding amount) is calculated from the occurring mask doming and the incident angle of an electron beam. FIG. 9 is a graph showing a relationship between Rₐ and the landing error according to the simulation. FIG. 9 shows a landing error with respect to Rₐ(2 Lₓ/3, 0)|.

The landing error that generally is suitable for the production and the practical use as a product is considered to be 100 μm] (broken line in FIG. 9) or less in a color picture tube of a 66 cm class product with general resolution. Based on the simulation results of mask doming shown in FIG. 9, in order to set the landing error caused by mask doming at a point on the X-axis away from the center by 2 Lₓ/3 to be 100 μm] or less, it is necessary to set |Rₐ| at that point to be about 1500 [mm] or less. In one example shown in FIG. 6, by adjusting |Rₐ| in the intermediate region on the X-axis (corresponding to 189 [mm]≦X≦213 [mm]) to be 1300 [mm] or less, the landing error is suppressed to be 90 μm] or less.

In the perforated curved-surface portion 7A having the above-mentioned curved surface shape, at the X-axis end portion and the Y-axis end portion, the mask curved-surface strength is determined by |Rᵣ| that is a minimum radius of curvature, irrespective of |R₁|. On the other hand, at the D₁-axis end portion, the mask curved-surface strength in the D₁-axis direction is determined by |R₁|. By setting these values as described above, the mask curved-surface strength, in particular, the mask curved-surface strength in the D₁-axis direction can be enhanced, compared with the case of having a perforated curved-surface portion in a conventional curved surface shape. Furthermore, by increasing |Rᵣ| on the D₁-axis, which does not influence the mask curved-surface strength, toward the D₁-axis end portion, the sagging amount at the D₁-axis end portion can be minimized. Furthermore, in the case where the mask curved-surface strength is kept to the same degree as that of a conventional example, the sagging amounts at the X-axis end portion and the D₁-axis end portion can be decreased further.

Furthermore, the mask doming amount depends upon an average radius of curvature between the minimum radius of curvature (see FIG. 10) and the maximum radius of curvature and the incident angle of an electron beam at an arbitrary site of the perforated curved-surface portion 7A. Therefore, even when Rₐ in the vicinity of the origin on the X-axis, where the landing error is small although the mask doming amount is relatively large, is set to be large, the degradation in color purity caused by mask doming can be suppressed while the sagging amount at the X-axis end portion is kept to the same degree as that of a conventional example, by decreasing Rₐ in the intermediate region on the X-axis where the landing error becomes largest. In one example shown in FIG. 6, Rₐ in the vicinity of the origin is 1800 [mm] or more, and Rₐ in the intermediate region on the X-axis is 1300 [mm] or less.

Hereinafter, the characteristics of the shadow mask 7 will be described specifically with reference to Tables 1 to 3. Table 1 shows the respective sagging amounts at the Y-axis end portion, the X-axis end portion, and the D₁-axis end portion of the shadow mask 7 (Example 1) of the above-mentioned one example. In Table 1, for comparison, the sagging amounts in a conventional shadow mask (conventional example) also are shown. An average radius of curvature in the Y-axis direction of a panel inner surface adapted to the shadow mask 7 in Example 1 is 1700 mm, and an average radius of curvature in the Y-axis direction of a panel inner surface adapted to the conventional shadow mask is 1300 mm. As shown in Table 1, in the shadow mask 7 of Example 1, compared with the conventional shadow mask, the sagging amount decreases by 23.3% at the Y-axis end portion, increases by 7.5% at the X-axis end portion, and does not change at the D₁-axis end portion. Thus, even in the case of using a low-transmittance panel in which the radius of curvature in the Y-axis direction of a panel inner surface is large, the sagging amount at the Y-axis end portion is improved significantly, and the sagging amounts at the X-axis end portion and the D₁-axis end portion are kept to the same degree as that of the conventional example, without being degraded significantly.

TABLE 1

| | Conventional Example | Example 1 | Change ratio |
|---|---|---|---|
| Y-axis end portion | 10.3 mm | 7.9 mm | −23.3% |
| X-axis end portion | 10.7 mm | 11.5 mm | 7.5% |
| D₁-axis end portion | 15.0 mm | 15.0 mm | 0% |

Furthermore, Table 2 shows mask curved-surface strength (i.e., buckling critical pressure amount) of the shadow mask 7 (Example 1) of the above-mentioned one example and a landing error caused by mask doming. In Table 2, for comparison, mask curved-surface strength and a landing error in a conventional shadow mask (conventional example) also are shown. As shown in Table 2, in the shadow mask 7 of Example 1, compared with the conventional shadow mask, the mask curved-surface strength decreases by 1%, and the landing error decreases by 7%. Thus, according to the present invention, even in the case of using a low-transmittance panel, the mask curved-surface strength and the landing error can be maintained at the same degrees as those of the conventional example.

TABLE 2

| | Conventional Example | Example 1 | Change ratio |
|---|---|---|---|
| Mask curved-surface | 130 Pa | 129 Pa | −1% |
| strength | | | |
| Landing error | 85 μm | 79 μm | −7% |

As described above, by using the shadow mask according to Embodiment 1, a low-transmittance panel can be applied without substantially decreasing the mask curved-surface strength, color purity, and resolution.

In the above, specific materials and various kinds of specific numerical values have been described with respect to the shadow mask 7. However, they are shown merely for illustrative purpose, and it is within the range of design selection to vary materials and various kinds of numerical values.

Furthermore, in the above, the case has been described in which the curved surface shape of the perforated curved-surface portion 7A of the shadow mask 7 is symmetric with respect to a plane including the tube axis and the X-axis, and is symmetric with respect to a plane including the tube axis and the Y-axis. However, the curved surface shape need not be symmetric with respect to these planes, as long as the above-mentioned conditions A1 to A4 are satisfied.

Furthermore, although the case of using a low-transmittance panel has been described in the above, one example of a shadow mask (Example 2) will be described, which is optimized with respect to a panel in a curved surface shape with a radius of curvature in the Y-axis direction smaller than that of a low-transmittance panel (i.e. with the same radius of curvature as that of the conventional example) and satisfies the above conditions A1-A4, B1, and B2. Table 3 shows the mask curved-surface strength (i.e., buckling critical pressure amount) of the shadow mask of Example 2 and a landing error caused by mask doming. In Table 3, for comparison, the mask curved-surface strength and the landing error in the conventional shadow mask (conventional example) also are shown. As shown in Table 3, in the shadow mask 7 of Example 2, compared with the conventional shadow mask, the mask curved-surface strength increases by 23%, and the landing error does not change. Thus, according to the present invention, while the resolution and the landing error caused by mask doming are kept to the same degrees as those of the conventional example, the mask curved-surface strength can be enhanced. This is because there is no degradation in mask curved-surface strength occurring in the case of using a low-transmittance panel.

TABLE 3

| | Conventional Example | Example 2 | Change ratio |
|---|---|---|---|
| Mask curved-surface | 130 Pa | 160 Pa | 23% |
| strength | | | |
| Landing error | 85 μm | 85 μm | 0% |

### Embodiment 2

In Embodiment 2, a color picture tube according to the present invention will be described. The color picture tube according to Embodiment 2 is the same as that according to Embodiment 1, except that the curved surface shape in the perforated curved-surface portion of the shadow mask is different. Therefore, only the curved surface shape of the perforated curved-surface portion will be described. The curved surface shape of the perforated curved-surface portion in the color picture tube according to Embodiment 2 is flatter, compared with the curved surface shape in Embodiment 1.

In-the same way as in Embodiment 1, the perforated curved-surface portion of the shadow mask of Embodiment 2 has a curved surface shape curved smoothly, and is symmetric with respect to a plane including a tube axis and an X-axis and with respect to a plane including the tube axis and a Y-axis. Thus, in the following, for simplicity of description, only the curved surface shape in a first quadrant in an X-Y coordinate system will be described.

The curved surface shape of the perforated curved-surface portion of the shadow mask according to Embodiment 2 satisfies the above conditions A1-A4, B1, B2, and further satisfies the following condition.

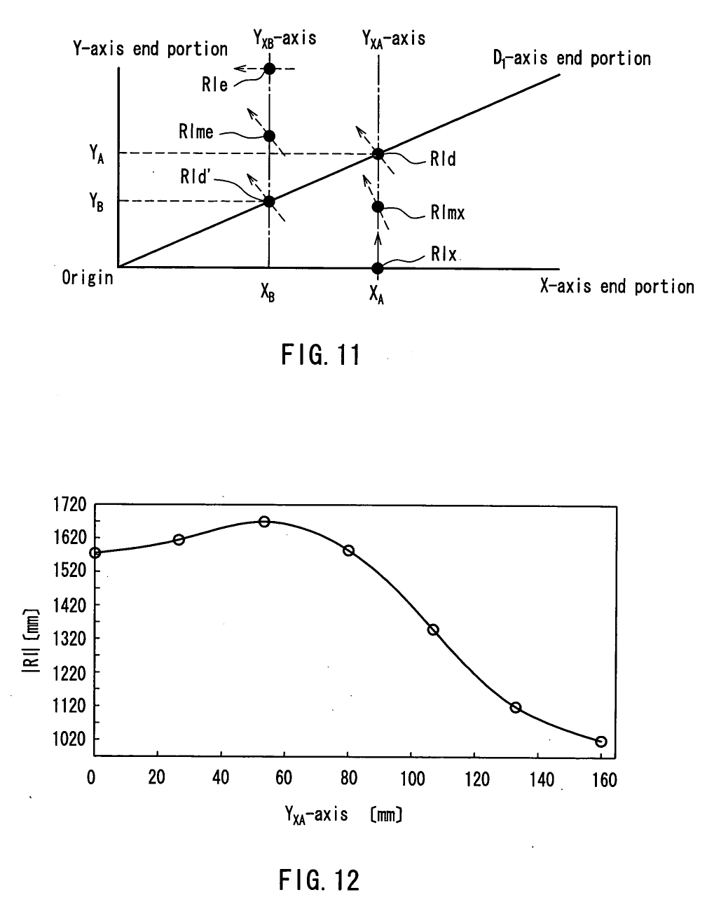

The condition of a change in a radius of curvature along an axis parallel to the Y-axis in the perforated curved-surface portion will be described with reference to FIGS. 11 to 13. FIG. 11 is a view illustrating the condition of a change in a radius of curvature along an axis parallel to the Y-axis in the perforated curved-surface portion of the shadow mask.

As shown in FIG. 11, in the perforated curved-surface portion, it is assumed that an axis parallel to the Y-axis including a point (X_{A}, 0) is a Y_{XA}-axis, an intersection between the Y_{YA}-axis and a D₁-axis is (X_{A}, Y_{A}), an axis parallel to the Y-axis including a point (X_{B}, 0) is a Y_{XB}-axis, and an intersection between the Y_{XB}-axis and the D₁-axis is (X_{B}, Y_{B}). Herein, X_{A} satisfies L_{X}/2≦X_{A}≦9 L_{X}/10, and X_{B} satisfies 0≦X_{B}<L_{X}/2.

Furthermore, on the Y_{XA}-axis, it is assumed that an average value of |R₁(X_{A}, Y)| in a region satisfying 0≦Y≦L_{Y}/10 is R₁ₓ, an average value of |R₁(X_{A}, Y)| in a region satisfying L_{Y}/5<Y<L_{Y}/2 is R₁ₘₓ, and an average value of |R₁(X_{A}, Y)| in a region satisfying (Y_{A}−9 L_{Y}/10)≦Y≦Y_{A} is R_{1d}. Furthermore, on the Y_{XB}-axis, it is assumed that an average value of |R₁(X_{B}, Y)| in a region satisfying (Y_{B}−L_{Y}/10)<Y<(Y_{B}+L_{Y}/10) is R_{1d′}, an average value of |R₁(X_{B}, Y)| in a region satisfying L_{Y}/2<Y<4 L_{Y}/5 is R₁ₘₑ, and an average value of |R₁(X_{B}, Y)| in a region satisfying 9 L_{Y}/10≦Y≦L_{Y} is R₁ₑ.

In the shadow mask of Embodiment 2, |R₁(X_{A}, Y)| on the Y_{XA}-axis takes a maximum value in a range satisfying L_{Y}/5<Y<L_{Y}/2, and |R₁(X_{B}, Y)| on the Y_{XB}-axis takes a maximum value in a range satisfying L_{Y}/2<Y<4 L_{Y}/5 (Condition D1).

Furthermore, the shadow mask of Embodiment 2 satisfies R₁ₓ<R₁ₘₓ>R_{1d}, and R_{1d′}<R₁ₘₑ>R₁ₑ (Condition D2).

The curved surface shape of the perforated curved-surface portion of the shadow mask of Embodiment 2 is flatter, compared with that of Embodiment 1, so that mask doming increases and color purity is likely to be degraded. In order to prevent this, on the X-axis, |R₁| in the vicinity of a point (X_{A}, 0) and |R₁| in the vicinity of a point (X_{B}, 0) may be sufficiently small. However, in this case, |R₁| increases on the D₁-axis, so that the mask curved-surface strength is degraded.

However, in the shadow mask of Embodiment 2, the changes in |R₁| along the Y_{XA}-axis and the Y_{XB}-axis satisfy the above conditions D1, D2. Therefore, |R₁| on the D₁-axis that greatly influences the mask curved-surface strength becomes substantially the same as that of Embodiment 1. Thus, in Embodiment 2, although the perforated curved-surface portion is flatter than that of Embodiment 1, the degradation in the mask curved-surface strength can be suppressed.

In general, the degree of degradation in color purity caused by mask doming on the Y_{XA}-axis and the Y_{XB}-axis is largest in the vicinity of the X-axis, and decreases with a distance from the X-axis.

In Embodiment 2, by satisfying the above condition D1, mask doming increases in a range of L_{Y}/5<Y<L_{Y}/2 where |R₁| is largest on the Y_{XA}-axis and in a range of L_{Y}/2<Y<4 L_{Y}/5 where |R₁| is largest on the Y_{XB}-axis. However, even if mask doming increases in these ranges, the mislanding of an electron beam with respect to a phosphor screen does not increase to such a degree as to exceed the width of a black matrix between adjacent phosphor layers, so that color purity hardly is degraded. On the other hand, in the vicinity of the X-axis where color purity is likely to be degraded, mask doming decreases relatively, so that the color purity of substantially the same degree as that of the conventional example can be obtained.

As described above, even if the curved surface shape of the perforated curved-surface portion is flatter than that of Embodiment 1, the degradation in mask curved-surface strength and degradation in color purity can be suppressed.

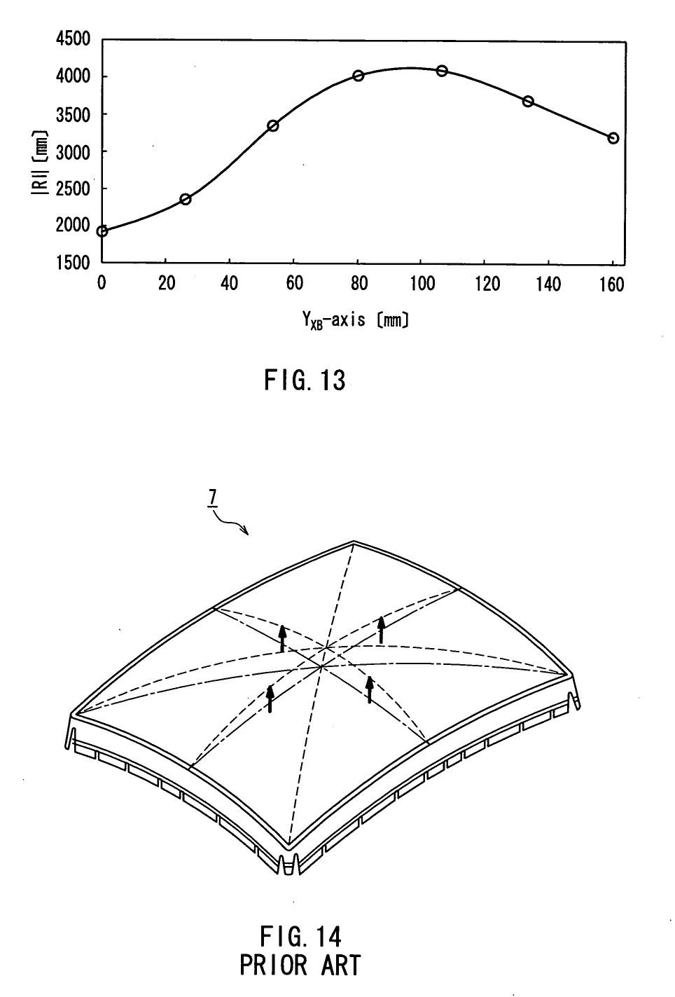

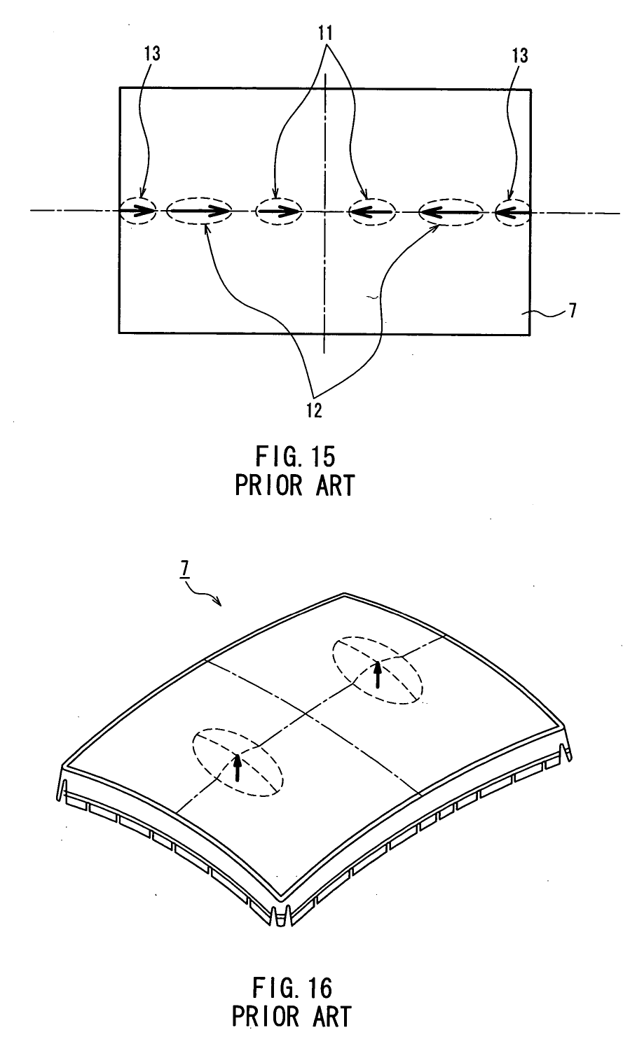

Hereinafter, one specific example will be described with reference to FIGS. 12 and 13. FIG. 12 is a graph showing a change in |R₁| along the Y_{XA}-axis in the perforated curved-surface portion of the shadow mask. FIG. 13 is a graph showing a change in |R₁| along the Y_{XB}-axis in the perforated curved-surface portion of the shadow mask.

FIG. 12 shows a change in |R₁(180, Y)| along the Y_{XA}-axis in the case where X_{A} is 180 [mm] (corresponding to 0.63×Lₓ). Y_{A} is about 104 [mm]. As shown in FIG. 12, |R₁(180, Y)| is represented by a function that takes a maximum value in a range where the distance from a point (180, 0) is more than 33 [mm] (corresponding to L_{Y}/5) and less than 83 [mm] (corresponding to L_{Y}/2). The maximum value is a point where Y is 50 [mm], and its value is 1670 [mm]. Furthermore, R₁ₓ<R₁ₘₓ>R_{1d} is satisfied.

FIG. 12 shows only the case where X_{A} is 180 [mm]. Even with respect to arbitrary X_{A} satisfying 142 [mm]≦X_{A}≦256 [mm], a change in |R₁(X_{A}, Y)| along the Y_{XA}-axis is represented by a function that takes a maximum value in a range satisfying 33 [mm]<Y<83 [mm] in the same way as in the function shown in FIG. 12, and R₁ₓ<R₁ₘₓ>R_{1d} is satisfied.

FIG. 13 shows a change in |R₁(X_{B}, Y)| along the Y_{XB}-axis in the case where X_{B} is 45 [mm] (corresponding to 0.16×L_{X}). Y_{B} is about 26 [mm]. As shown in FIG. 13, |R₁(45, Y)| is represented by a function that takes a maximum value in a range where the distance from a point (45, 0) is more than 83 [mm] (corresponding to L_{Y}/2) and less than 132 [mm] (corresponding to 4 L_{Y}/5). The maximum value is a point where Y is 99 [mm], and its value is 4100 [mm]. Furthermore, R_{1d′}<R₁ₘₑ>R₁ₑ is satisfied.

FIG. 13 shows only the case where X_{B} is 45 [mm]. However, even with respect to arbitrary X_{B} satisfying 28 [mm]≦X_{B}≦142 [mm] (corresponding to L_{X}/2), a change in |R₁(X_{B}, Y)| along the Y_{XB}-axis is represented by a function that takes a maximum value in a range satisfying 83 [mm]<Y<132 [mm] in the same way as in the function shown in FIG. 13, and R_{1d′}<R₁ₘₑ>R₁ₑ is satisfied.

In the above, specific materials and various kinds of specific numerical values have been described with respect to the shadow mask. However, they are shown merely for illustrative purpose, and it is within the range of design selection to vary materials and various kinds of numerical values.

Furthermore, in the above, the case has been described in which the curved surface shape of the perforated curved-surface portion of the shadow mask is symmetric with respect to a plane including the tube axis and the X-axis, and is symmetric with respect to a plane including the tube axis and the Y-axis. The curved surface shape need not be symmetric with respect to these planes.

The present invention can be used for applying a low-transmittance panel to a color picture tube having a shadow mask without degrading shock resistance, resolution, color purity (contrast) depending upon mask doming, a grade of a phosphor screen, and the like, compared with a panel having surface coating, a film, or the like in a useful display area. More specifically, the present invention can be used for decreasing the cost of a color picture tube, using a low-transmittance panel.

Furthermore, the present invention can be used for enhancing mask shock resistance, i.e., mask curved-surface strength in a color picture tube including a shadow mask, and a panel having a radius of curvature of a panel inner surface equal to that of a conventional example.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color picture tube, comprising:
a panel having an outer surface with a radius of curvature of 10,000 mm or more;
a funnel connected to the panel;
a phosphor screen provided on an inner surface of the panel;
an electron gun provided in the funnel; and
a shadow mask provided in the panel so as to be opposed to the phosphor screen and having a substantially rectangular perforated curved-surface portion with a plurality of apertures,
wherein assuming that an axis in a long side direction of the perforated curved-surface portion, which passes through a center of the perforated curved-surface portion, is an X-axis, an axis in a short side direction of the perforated curved-surface portion, which passes through the center, is a Y-axis, a length from the center to an end portion on the X-axis of the perforated curved-surface portion is Lₓ, a length from the center to an end portion on the Y-axis of the perforated curved-surface portion is L_{Y}, a radius of curvature in a radial direction of the perforated curved-surface portion at an arbitrary point (X, Y) of the perforated curved-surface portion is Rᵣ(X, Y) and a radius of curvature in a direction vertical to the radial direction of the perforated curved-surface portion is R₁(X, Y), and a main radius of curvature group consists of a maximum radius of curvature and a minimum radius of curvature at the arbitrary point (X, Y) of the perforated curved-surface portion,
at an arbitrary point on the X-axis and the Y-axis, Rᵣ(X, Y) is one radius of curvature of the main radius of curvature group, and R₁(X, Y) is the other radius of curvature of the main radius of curvature group,
on the Y-axis, |Rᵣ(0, Y)|<|R₁(0, Y)| is satisfied at an arbitrary point in a range where the distance from the center is L_{Y} or less, and
on the X-axis, |R,(X, 0)|>|R₁(X, 0)| is satisfied at an arbitrary point in a range where the distance from the center is Lₓ/3 or less, and |Rᵣ(X, 0)|<|R₁(X, 0)| is satisfied at an arbitrary point in a range where the distance from the center is 3 Lₓ/4 to Lₓ.

2. The color picture tube according to claim 1, wherein assuming that an axis which is included in a diagonal plane including a tube axis and a point where a long side and a short side of the perforated curved-surface portion cross each other, passes through the center of the perforated curved-surface portion, and is vertical to the tube axis is a D-axis, and a length from the center to an end portion on the D-axis of the perforated curved-surface portion is L_{D},
on the D-axis, |Rᵣ(X, Y)|>|R₁(X, Y)| is satisfied at an arbitrary point in a range where the distance from the center is L_{D}/3 or less, and |Rᵣ(X, Y)|>|R₁(X, Y)| is satisfied at an arbitrary point in a range where the distance from the center is 3 L_{D}/4 to L_{D}.

3. The color picture tube according to claim 1, wherein assuming that an average of |Rᵣ(X, Y)| and |R₁(X, Y)| at the arbitrary point (X, Y) of the perforated curved-surface portion is Rₐ(X, Y),
a function representing a change in Rₐ(X, Y) with respect to the distance from the center along the X-axis takes a minimum value in a range where the distance from the center is L_{X}/2 to 9 L_{X}/10.

4. The color picture tube according to claim 3, wherein assuming that an average value of Rₐ(X, 0) on the X-axis in a vicinity of the center is R_{ac}, an average value of Rₐ(X, 0) on the X-axis in a range where the distance from the center is 2 L_{X}/3 to 3 L_{X}/4 is Rₐₘ, and an average value of Rₐ(X, 0) on the X-axis in a vicinity of an end portion on the X-axis is Rₐₑ,
R_{ac}>Rₐₘ<Rₐₑ is satisfied.

5. The color picture tube according to claim 3, wherein assuming that an axis which passes through a point (X_{A}, 0) on the X-axis where the distance from the center is an arbitrary distance X_{A} of L_{X}/2 to 9 L_{X}/10 and is parallel to the Y-axis is a Y_{XA}-axis, and an axis which passes through a point (X_{B}, 0) on the X-axis where the distance from the center is an arbitrary distance X_{B} of 0 to L_{X}/2, and is parallel to the Y-axis is a Y_{XB}-axis,
a function representing a change in |R1(X_{A}, Y)| with respect to a distance from the point (X_{A}, 0) along the Y_{XA}-axis takes a maximum value in a range where a distance from the point (X_{A}, 0) is more than L_{Y}/5 and less than L_{Y}/2, and
a function representing a change in |R₁(X_{B}, Y)| with respect to a distance from the point (X_{B}, 0) along the Y_{XB}-axis takes a maximum value in a range where a distance from the point (X_{B}, 0) is more than L_{Y}/2 and less than 4 L_{Y}/5.

6. The color picture tube according to claim 5, wherein assuming that an average value of |R₁(X_{A}, Y)| in a vicinity of an intersection between the X-axis and the Y_{XA}-axis is R₁ₓ, an average value of |R₁(X_{A}, Y)| on the Y_{XA}-axis in a range where a distance from the X-axis is more than L_{Y}/5 and less than L_{Y}/2 is R₁ₘₓ, an average value of |R1(X_{A}, Y)| in a vicinity of an intersection between the D-axis and the Y_{XA}-axis is R_{1d}, an average value of |R₁(X_{B}, Y)| in a vicinity of an intersection between the D-axis and the Y_{XB}-axis is R_{1d′}, an average value of |R₁(X_{B}, Y)| on the Y_{XB}-axis in a range where the distance from the X-axis is more than L_{Y}/2 and less than 4 L_{Y}/5 is R₁ₘₑ, and an average value of |R₁(X_{B}, Y)| in a vicinity of an end portion on the Y_{XB}-axis of the perforated curved-surface portion is R₁ₑ,
R₁ₓ<R₁ₘₓ>R_{1d} is satisfied, and
R_{1d}<R₁ₘₑ>R₁ₑ is satisfied.
